(19) United States
(12) Patent Application Publication
(10) Pub. No.: US 2025/0276668 A1
(43) Pub. Date: Sep. 4, 2025

(54) VEHICLE, SERVER, AND VEHICLE CONTROL SYSTEM

(71) Applicant: TOYOTA JIDOSHA KABUSHIKI KAISHA, Toyota-shi (JP)

(72) Inventors: Yasuhisa Ohta, Toyota-shi (JP); Akihiro Muramatsu, Toyota-shi (JP); Kazunori Sobue, Aichi (JP)

(73) Assignee: TOYOTA JIDOSHA KABUSHIKI KAISHA, Toyota-shi (JP)

(21) Appl. No.: 19/044,419

(22) Filed: Feb. 3, 2025

(30) Foreign Application Priority Data
Feb. 29, 2024 (JP) 2024-030140

(51) Int. Cl. B60R 25/04; B60R 25/102; B60R 25/33

(52) U.S. Cl. CPC B60R 25/04; B60R 25/102; B60R 25/33; B60R 2025/0405; B60R 2025/0415

(57) ABSTRACT

A vehicle includes an on-board navigation device configured to repeatedly obtain the location of the vehicle through GPS and an on-board immobilizer device. The on-board immobilizer device is configured to activate a remote immobilizer when the location of the vehicle, which is obtained from the on-board navigation device, is outside a predetermined geographical region. The on-board immobilizer device is configured to prohibit operation of a drive system of the vehicle while the remote immobilizer is active. When the remote immobilizer is activated, the activation of the remote immobilizer is notified to a terminal of an authentic user of the vehicle by directly the vehicle or via a server.

### CROSS-REFERENCE TO RELATED APPLICATIONS

This application is based upon and claims the benefit of priority from Japanese Patent Application No. 2024-030140, filed on Feb. 29, 2024, the entire contents of which are incorporated herein by reference.

### BACKGROUND

### 1. Field

The following description relates to a vehicle, a server, and a vehicle control system.

### 2. Description of Related Art

An immobilizer is a known anti-theft device used for a vehicle. In an example of the immobilizer, an immobilizer key is carried by a user and communicates with a computer mounted on the vehicle. Only when identification information registered to the immobilizer key conforms to identification information registered to the vehicle, the engine of the vehicle is permitted to start. More specifically, when an immobilizer is mounted on a vehicle, the engine of the vehicle cannot be started unless identification information is electronically verified even if a physical key is duplicated. This hampers a theft of the vehicle using only a duplicated physical key.

In addition to the immobilizer described above, the use of a remote immobilizer system increases security against theft. Japanese Laid-Open Patent Publication No. 2003-146185 discloses an example of a remote immobilizer system. The remote immobilizer system includes a vehicle, a server, and a user terminal. The user terminal allows the user to request that the server activate the remote immobilizer. In an example, the user may request that the server activate the remote immobilizer during a time when the vehicle is not planned to be used. In accordance with the request received from the user terminal, the server communicates with the vehicle and activates the remote immobilizer. While the remote immobilizer is active, the engine cannot be started even by using the immobilizer key. This prevents, for example, theft using a relay attack, which relays a radio wave emitted from the immobilizer key to fraudulently perform verification of electronic identification information with the vehicle.

While the remote immobilizer is inactive, the security against theft is decreased. While the remote immobilizer is inactive, if a thief drove the vehicle to a distant site, it would be difficult to reclaim the vehicle from the thief.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter

In an aspect of the present disclosure, a vehicle includes an on-board navigation device configured to obtain a location of the vehicle, and an on-board immobilizer device. The on-board immobilizer device is configured to activate a function of a remote immobilizer when the location of the vehicle obtained from the on-board navigation device is outside a predetermined geographical region. The function of the remote immobilizer prohibits operation of a drive system of the vehicle through a remote operation. The on-board immobilizer device is configured to prohibit operation of the drive system of the vehicle while the function of the remote immobilizer is active.

In an aspect of the present disclosure, a server includes processing circuitry configured to obtain a location of a vehicle from the vehicle, and remotely operate an on-board immobilizer device mounted on the vehicle to activate a function of a remote immobilizer when the location of the vehicle that is obtained is outside a predetermined geographical region. The on-board immobilizer device is configured to prohibit operation of a drive system of the vehicle while the function of the remote immobilizer is active.

In an aspect of the present disclosure, a vehicle control system includes a vehicle and a server. The vehicle is configured to obtain a location of the vehicle and request that the server transmit an instruction to the vehicle for activating a function of a remote immobilizer through a remote operation when the location of the vehicle that is obtained is outside a predetermined geographical region. The function of the remote immobilizer prohibits operation of a drive system of the vehicle. When receiving the request, the server is configured to transmit the instruction for activating the function of the remote immobilizer to the vehicle so that an on-board immobilizer device mounted on the vehicle is remotely operated to activate the function of the remote immobilizer. The on-board immobilizer device is configured to prohibit operation of the drive system of the vehicle while the function of the remote immobilizer is active.

Other features and aspects will be apparent from the following detailed description, the drawings, and the claims.

### BRIEF DESCRIPTION OF THE DRAWINGS

FIG. 1 is a diagram showing a vehicle according to a first embodiment.

FIG. 2 is a flowchart showing a process executed by the vehicle shown in FIG. 1.

FIG. 3 is a diagram showing a user interface for setting day and time that are referred to in the process shown in FIG. 2.

FIG. 4 is a flowchart showing a process executed by the vehicle shown in FIG. 1.

FIG. 5 is a flowchart showing a process for transmitting an activation state of a remote immobilizer to a user terminal.

FIG. 6 is a flowchart showing a process for deactivating the remote immobilizer in accordance with a request from a user.

FIG. 7 is a diagram showing a server according to a second embodiment.

FIG. 8 is a flowchart showing a process executed by the server shown in FIG. 7.

FIG. 9 is a diagram showing a vehicle control system according to a third embodiment.

FIG. 10 is a flowchart showing a process executed by the vehicle control system shown in FIG. 9.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

The vehicle according to the first embodiment, the server according to the second embodiment, and the vehicle control system according to the third embodiment will now be described with reference to the drawings.

### First Embodiment

### Overview

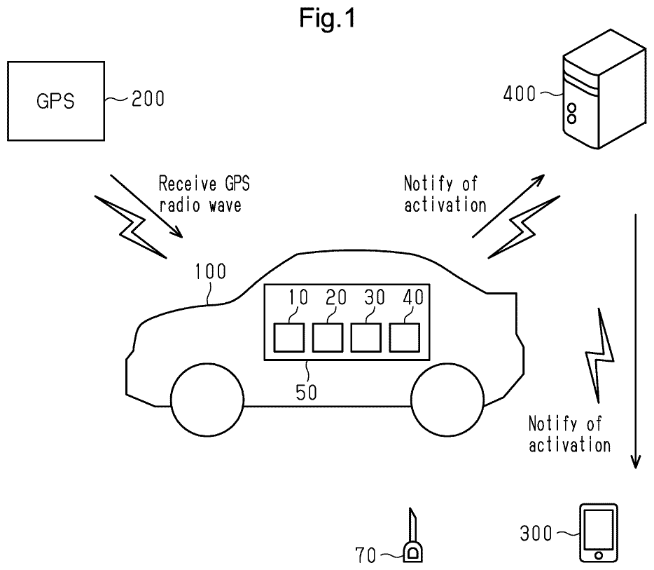

The overview of the first embodiment will now be described with reference to FIG. 1. A vehicle control system includes a vehicle 100 and a server 400. The vehicle 100 includes a control unit 50. The control unit 50 includes an on-board navigation device 10, an on-board immobilizer device 20, and a display 30, and an on-board communication device 40. The on-board navigation device 10 can be configured to repeatedly obtain the location of the vehicle 100 through a global positioning system 200 (GPS). The on-board immobilizer device 20 obtains the location of the vehicle 100 from the on-board navigation device 10. When the location of the vehicle 100 is outside a predetermined geographical region, the on-board immobilizer device 20 activates a remote immobilizer. While the remote immobilizer is active, the on-board immobilizer device 20 prohibits operation of a drive system of the vehicle 100.

The predetermined geographical region is set through machine learning based on travel history of the vehicle 100. In an example, a location where the user frequently parks the vehicle 100 is centered in a region having a fixed area. The region having the fixed area is set to the geographical region. In an example, a location where the user regularly parks the vehicle 100 is centered in a region having a fixed area. The region having the fixed area is set to the geographical region. In an example, a range includes a path connecting two locations where the user frequently or regularly parks the vehicle 100. The two locations are separated from each other by a few kilometers or more. The range including the path is set to the graphical region. In an example, when the path has multiple points, and each point serves as the center of a range having a fixed area, the range including the path is an overlap of the ranges corresponding to the multiple points. The geographical region may be manually selected and set by the user. In an example, the user defines a range from a map of the on-board navigation device 10 to set the geographical region. The predetermined geographical region may include multiple geographical regions. With this configuration, when the vehicle 100 is moved outside of one of the predetermined geographical regions, the on-board immobilizer device 20 activates the remote immobilizer.

When the remote immobilizer is active, the drive system of the vehicle 100 cannot be activated even using an authentic immobilizer key 70. In other words, even when identification information registered to the immobilizer key 70 conforms to identification information registered to the vehicle 100, the drive system of the vehicle 100 cannot be activated. The remote immobilizer may be deactivated by inputting identification information to the display 30 of the vehicle 100. This will be described later with reference to FIG. 4. The remote immobilizer may be deactivated by requesting deactivation of the remote immobilizer from a terminal 300 of the user. This will be described later with reference to FIG. 6.

The on-board communication device 40 is configured to communicate with a device arranged outside the vehicle 100. In the example shown in FIG. 1, when the on-board immobilizer device 20 activates the remote immobilizer, the on-board communication device 40 notifies the server 400 that the remote immobilizer is activated. Then, the server 400 notifies the terminal 300 of the user that the remote immobilizer is activated. Instead of the example shown in FIG. 1, the on-board communication device 40 may directly communicate with the terminal 300 of the user without using the server 400. In any of the configurations, when the on-board immobilizer device 20 activates the remote immobilizer, the on-board communication device 40 is configured to notify the terminal 300 of an authentic user of the vehicle 100 that the remote immobilizer is activated.

### Operation to Activate Remote Immobilizer

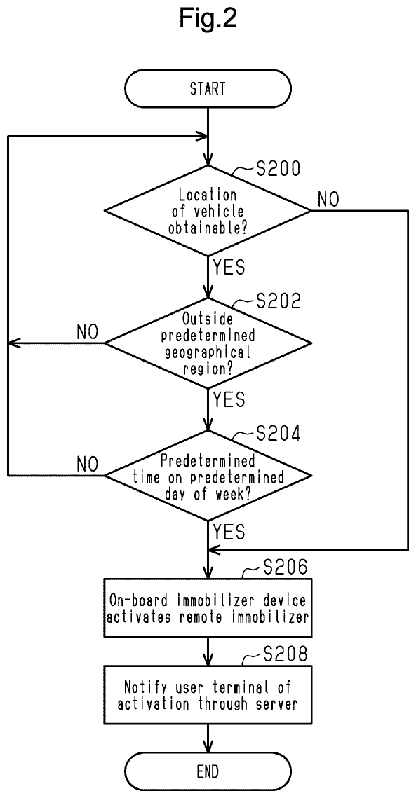

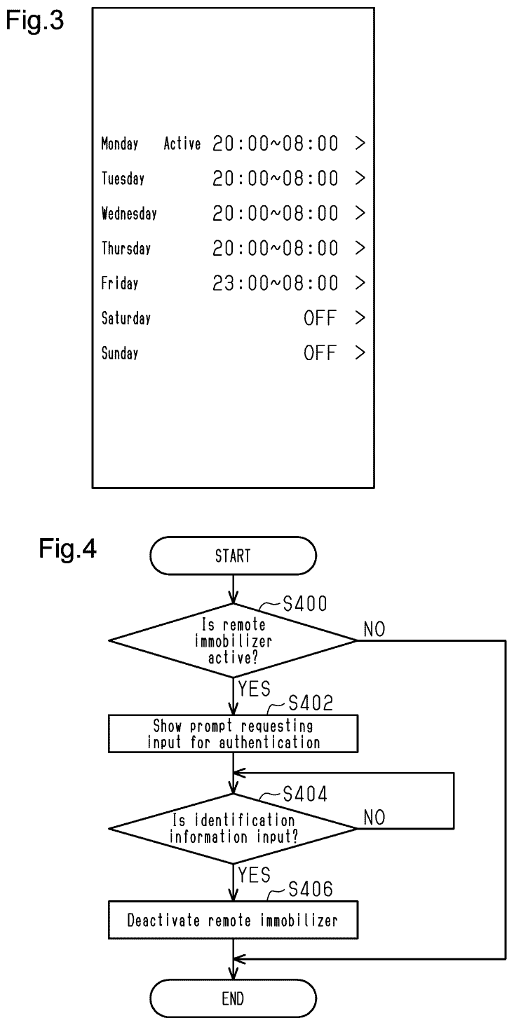

With reference to FIGS. 2 and 3, the operation for activating the remote immobilizer will now be described. The process shown in FIG. 2 is automatically started subsequent to activation of the drive system of the vehicle 100. Also, the process shown in FIG. 2 automatically starts when the remote immobilizer is switched from the active state to the inactive state during operation of the drive system of the vehicle 100.

As described above, the on-board immobilizer device 20 is configured to obtain the location of the vehicle 100 from the on-board navigation device 10. However, when a thief removes the on-board navigation device 10 from the vehicle 100, the on-board immobilizer device 20 fails to obtain the location of the vehicle 100. In step S200, the on-board immobilizer device 20 determines whether the location of the vehicle 100 can be obtained. If the location of the vehicle 100 can be obtained (S200: YES), the on-board immobilizer device 20 proceeds to step S202. If the location of the vehicle 100 cannot be obtained (S200: NO), the on-board immobilizer device 20 proceeds to step S206. In step S206, the on-board immobilizer device 20 activates the remote immobilizer.

In step S202, the on-board immobilizer device 20 determines whether the location of the vehicle 100 is outside the predetermined geographical region. If a negative determination is made in step S202 (S202: NO), the on-board immobilizer device 20 returns to step S200. If an affirmative determination is made in step S202 (S202: YES), the on-board immobilizer device 20 proceeds to step S204.

In step S204, the on-board immobilizer device 20 determines whether the present point in time belongs to a predetermined time on a predetermined day of week. If a negative determination is made in step S204 (S204: NO), the on-board immobilizer device 20 returns to step S200. If an affirmative determination is made in step S204 (S204: YES), the on-board immobilizer device 20 proceeds to step S206.

With reference to FIG. 3, the predetermined time on the predetermined day of week that is referred to in step S204 will be described. FIG. 3 is an example of an image shown on a screen of the terminal 300 by an application installed to the terminal 300 owned by the user. FIG. 3 is an example in which the process of step S204 is executed at or after 20 o′clock on Monday and thus the remote immobilizer is active. In the example shown in FIG. 3, the indication of “active” denotes that the remote immobilizer is in the active state. The example shown in FIG. 3 indicates, for each day of week, the time during which the remote immobilizer is active when the location of the vehicle 100 is outside the predetermined geographical region. In the example shown in FIG. 3, the indication “OFF” denotes no setting of time during which the remote immobilizer is active when the location of the vehicle 100 is outside the predetermined geographical region. More specifically, the indication “OFF” denotes that the function for activating the remote immobilizer when the location of the vehicle 100 is outside the predetermined geographical region is not activated on that day. The user is allowed to set time for each day of week for whether to activate the remote immobilizer when the location of the vehicle 100 is outside the predetermined geographical region. Thus, when the location of the vehicle 100 obtained during a predetermined time on a predetermined day of week is outside the predetermined geographical region, the on-board immobilizer device 20 is configured to activate the remote immobilizer. During time other than the predetermined time on the predetermined day of week, the on-board immobilizer device 20 is configured not to activate the remote immobilizer even when the location of the vehicle 100 is outside the predetermined geographical region. The user may set time without specifying the days of week. Thus, when the location of the vehicle 100 obtained during the predetermined time is outside the predetermined geographical region, the on-board immobilizer device 20 is configured to activate the remote immobilizer. During time other than the predetermined time, the on-board immobilizer device 20 is configured not to activate the remote immobilizer even when the location of the vehicle 100 is outside the predetermined geographical region. The user may set only a day of week without specifying times. Thus, when the location of the vehicle 100 obtained on the predetermined day of week is outside the predetermined geographical region, the on-board immobilizer device 20 is configured to activate the remote immobilizer. On a day other than the predetermined day of week, the on-board immobilizer device 20 is configured not to activate the remote immobilizer even when the location of the vehicle 100 is outside the predetermined geographical region.

Referring to FIG. 2, in step S206, the on-board immobilizer device 20 activates the remote immobilizer. Then, the on-board immobilizer device 20 proceeds to step S208. In step S208, the on-board immobilizer device 20 notifies the terminal 300 of the user that the remote immobilizer is activated through the on-board communication device 40 and the server 400.

### Operation for Attempt to Activate Drive System

With reference to FIG. 4, the operation performed when an attempt is made to activate the drive system of the vehicle 100 will be described. An attempt to activate the drive system of the vehicle 100 triggers a start of the process shown in FIG. 4. In an example, the process shown in FIG. 4 starts when the immobilizer key 70 is used to attempt an activation of the drive system of the vehicle 100. The process shown in FIG. 4 also starts when a thief uses a radio signal received from the immobilizer key 70 and attempts an activation of the drive system. In step S400, the on-board immobilizer device 20 determines whether the remote immobilizer is active. If the remote immobilizer is inactive (S400: NO), the on-board immobilizer device 20 ends the process shown in FIG. 4.

If the remote immobilizer is active (S400: YES), the on-board immobilizer device 20 proceeds to step S402. In step S402, the on-board immobilizer device 20 shows a prompt, on the display 30 of the vehicle 100, requesting input for authentication. The authentication may be performed by the user manually inputting identification information into the display 30. Alternatively, the authentication may be performed by the user using the terminal 300 to send identification information stored in the terminal 300 to the on-board immobilizer device 20. In other words, the authentication may be performed using a digital key. Alternatively, the authentication may be ear acoustic authentication that is performed by the on-board immobilizer device 20 through an earbud-type device attached to the ear of the user. The ear acoustic authentication is biometric authentication using the echo of sound specified by the shape of an ear hole. In other words, the authentication may be performed using a hearable device. Then, the on-board immobilizer device 20 proceeds to step S404. In step S404, the on-board immobilizer device 20 determines whether predetermined identification information corresponding to the prompt is input. In an example, the identification information that is input is, for example, a password that is set in advance by the user. In an example, the identification information that is input may be a personal identification number that is set in advance by the user. In an example, the identification information that is input may be biometric information such as a fingerprint, a voice, or a retina of the user. If the identification information is not input (S404: NO), the on-board immobilizer device 20 repeats the process of step S404. If the identification information is input (S404: YES), the on-board immobilizer device 20 proceeds to step S406.

In step S406, the on-board immobilizer device 20 deactivates the remote immobilizer.

According to steps S400 and S402, when an attempt is made to activate the drive system of the vehicle 100 while the remote immobilizer is active, the on-board immobilizer device 20 shows a prompt, on the display 30 of the vehicle 100, requesting input for authentication. According to steps S404 and S406, when the predetermined identification information corresponding to the prompt is input, the on-board immobilizer device 20 deactivates the remote immobilizer.

### Operation Related to Query About Activation State of Remote Immobilizer

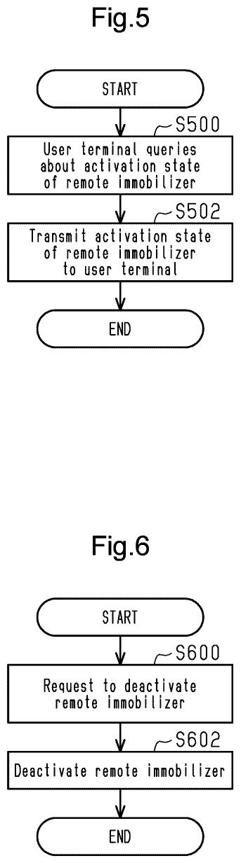

With reference to FIG. 5, the operation related to a query about the activation state of the remote immobilizer will be described. In step S500, the terminal 300 of the user queries the vehicle 100 or the server 400 about the activation state of the remote immobilizer. More specifically, the terminal 300 transmits a signal for querying the activation state of the remote immobilizer to the vehicle 100 or the server 400. The operation for transmitting the signal is performed using an application installed on the terminal 300. The signal transmitted from the terminal 300 is received by the on-board communication device 40 or the server 400. When the server 400 receives the signal, the server 400 notifies the vehicle 100 that the signal for querying the activation state of the remote immobilizer is transmitted from the terminal 300. In step S502, the activation state of the remote immobilizer is transmitted to the terminal 300 of the user. More specifically, the on-board communication device 40 transmits information indicating the activation state of the remote immobilizer to the terminal 300 that has transmitted the signal. Thus, the activation state of the remote immobilizer is notified to the terminal 300.

As described above, the on-board communication device 40 is configured to transmit the activation state of the remote immobilizer to the terminal 300 of the authentic user of the vehicle 100 in response to a request from the terminal 300.

### Operation to Deactivate Remote Immobilizer in Response to User Request

With reference to FIG. 6, the operation to deactivate the remote immobilizer in response to a request from the user will be described. In step S600, the terminal 300 of the user requests the vehicle 100 or the server 400 to deactivate the remote immobilizer. In this case, the one of the vehicle 100 and the server 400 that has received the request performs user authentication. The authentication may be performed using, for example, a password or biometric information such as a fingerprint, a voice, or a retina of the user. Unless the authentication is successfully completed, the request is not accepted. More specifically, a request for deactivation of the remote immobilizer is transmitted from the terminal 300 to the vehicle 100 or the server 400. The operation for transmitting the request is performed using an application installed on the terminal 300. If the user authentication is successfully completed, the on-board communication device 40 or the server 400 accepts the request from the terminal 300. When the server 400 receives the request, the server 400 notifies the vehicle 100 that the request for deactivation of the remote immobilizer is transmitted from the terminal 300. In step S602, the remote immobilizer is deactivated. More specifically, the on-board communication device 40 notifies the on-board immobilizer device 20 that the request for deactivation of the remote immobilizer is received. Then, the on-board immobilizer device 20 deactivates the remote immobilizer. In other words, the remote immobilizer is switched off from the active state.

As described above, the on-board communication device 40 is configured to deactivate the remote immobilizer when receiving a request for deactivation of the remote immobilizer from the terminal 300 of the authentic user of the vehicle 100 while the remote immobilizer is active.

### Operation of First Embodiment

If the location of the vehicle 100 is outside the predetermined geographical region during a predetermined time on a predetermined day of week (S202: YES, S204: YES), the remote immobilizer is activated (S206). As described above, when the remote immobilizer is active, the drive system of the vehicle 100 cannot be activated even using an authentic immobilizer key 70. If the location of the vehicle 100 cannot be obtained from the on-board navigation device 10 (S200: NO), the remote immobilizer is activated. That is, the remote immobilizer is activated regardless of whether the location of the vehicle 100 is outside the predetermined geographical region.

### Advantages of First Embodiment

(1-1) The vehicle 100 includes the on-board navigation device 10, which is configured to repeatedly obtain the location of the vehicle 100 through the global positioning system 200, and the on-board immobilizer device 20. The on-board immobilizer device 20 is configured to activate the remote immobilizer when the location of the vehicle 100, which is obtained from the on-board navigation device 10, is outside the predetermined geographical region. The on-board immobilizer device 20 is configured to prohibit operation of the drive system of the vehicle 100 while the remote immobilizer is active.

For example, the user sets, in advance, a region where the user normally drives the vehicle 100 as the geographical region. With this configuration, when the location of the vehicle 100 is outside the predetermined geographical region, the remote immobilizer is activated. As a result, operation of the drive system is prohibited. Therefore, a thief could succeed in activating the drive system one time and drive the vehicle 100 to a region outside the geographical region. However, once the drive system is deactivated, the vehicle 100 cannot be activated again outside the geographical region. This hinders the thief from driving the vehicle 100 far away from the geographical region.

(1-1-a) The above-described configuration allows for activation of the remote immobilizer without communication with a device arranged outside the vehicle 100. Therefore, even when the vehicle 100 fails to communicate with the device arranged outside the vehicle 100, the remote immobilizer is activated.

(1-2) The vehicle 100 further includes the on-board communication device 40 configured to communicate with a device arranged outside the vehicle 100. When the on-board immobilizer device 20 activates the remote immobilizer, the on-board communication device 40 is configured to notify the terminal 300 of the authentic user of the vehicle 100 that the remote immobilizer is activated.

With this configuration, a notification of the activation of the remote immobilizer is issued to the terminal 300 of the authentic user. Therefore, the user is less likely to be unaware of the activation of the remote immobilizer. The user may quickly notice that the vehicle 100 is driven to the outside of the geographical region.

(1-3) When the location of the vehicle 100 obtained during the predetermined time is outside the predetermined geographical region, the on-board immobilizer device 20 is configured to activate the remote immobilizer. During time other than the predetermined time, the on-board immobilizer device 20 is configured not to activate the remote immobilizer even when the location of the vehicle 100 is outside the predetermined geographical region.

This configuration allows the user to set time as the condition for activating the remote immobilizer.

(1-4) When the location of the vehicle 100 obtained on the predetermined day of week is outside the predetermined geographical region, the on-board immobilizer device 20 is configured to activate the remote immobilizer. On a day other than the predetermined day of week, the on-board immobilizer device 20 is configured not to activate the remote immobilizer even when the location of the vehicle 100 is outside the predetermined geographical region.

This configuration allows the user to set a day of week as the condition for activating the remote immobilizer.

(1-5) When the location of the vehicle 100 obtained during a predetermined time on a predetermined day of week is outside the predetermined geographical region, the on-board immobilizer device 20 is configured to activate the remote immobilizer. During time other than the predetermined time on the predetermined day of week, the on-board immobilizer device 20 is configured not to activate the remote immobilizer even when the location of the vehicle 100 is outside the predetermined geographical region.

This configuration allows the user to set a day of week and time as the condition for activating the remote immobilizer.

(1-6) The predetermined geographical region is set through machine learning based on travel history of the vehicle 100.

This configuration reduces the burden of the user of the vehicle 100 to set a geographical region.

(1-7) The on-board immobilizer device 20 is configured to set multiple geographical regions as the predetermined geographical region. When the vehicle 100 is moved outside of one of the predetermined geographical regions, the on-board immobilizer device 20 is configured to activate the remote immobilizer.

This configuration allows multiple geographical regions to be set in advance.

(1-8) The on-board immobilizer device 20 is configured to activate the remote immobilizer when the location of the vehicle 100 cannot be obtained from the on-board navigation device 10.

With this configuration, even when the thief removes the on-board navigation device 10 from the vehicle 100, the remote immobilizer is activated. That is, even when the thief disables the ability to obtain the location of the vehicle 100, the remote immobilizer is activated. This increases the security against theft.

(1-9) When an attempt is made to activate the drive system of the vehicle 100 while the remote immobilizer is active, the on-board immobilizer device 20 shows a prompt, on the display 30 of the vehicle 100, requesting input for authentication. If the predetermined identification information corresponding to the prompt is input, the on-board immobilizer device 20 is configured to deactivate the remote immobilizer.

With this configuration, even when the remote immobilizer is active, the authentic user who can provide the identification information may enter the identification information to deactivate the remote immobilizer.

(1-10) The vehicle 100 includes the on-board communication device 40 configured to communicate with a device arranged outside the vehicle 100. The on-board communication device 40 is configured to transmit the activation state of the remote immobilizer to the terminal 300 of the authentic user of the vehicle 100 in response to a request from the terminal 300.

With this configuration, the user may check the activation state of the remote immobilizer by performing an inquiry on the on-board communication device 40.

(1-11) The vehicle 100 includes the on-board communication device 40 configured to communicate with a device arranged outside the vehicle 100. The on-board communication device 40 is configured to deactivate the remote immobilizer when receiving a request for deactivation of the remote immobilizer from the terminal 300 of the authentic user of the vehicle 100 while the remote immobilizer is active.

This configuration allows the user of the vehicle 100 to deactivate the remote immobilizer using the terminal 300 carried by the user.

### Second Embodiment

A second embodiment of the present invention will now be described with reference to the drawings. In the second embodiment, the same configurations as the first embodiment will not be described in detail.

The second embodiment differs from the first embodiment in the following points. In the second embodiment, the server 400 obtains the location of the vehicle 100 from the vehicle 100. In the first embodiment, the server 400 does not obtain the location of the vehicle 100. In the second embodiment, the server 400 determines whether the location of the vehicle 100 is outside the predetermined geographical region. In the first embodiment, the vehicle 100 determines whether the location of the vehicle 100 is outside the predetermined geographical region.

### Overview

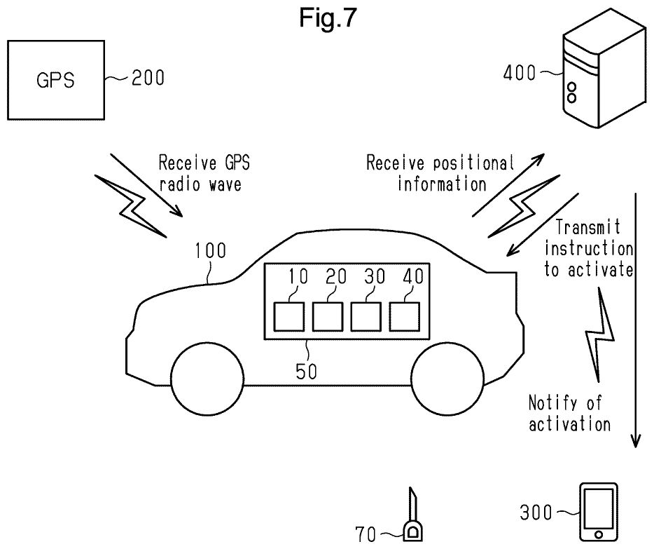

The overview of the second embodiment will now be described with reference to FIG. 7. The vehicle 100 includes the on-board navigation device 10 configured to repeatedly obtain the location of the vehicle 100 through the global positioning system 200. The server 400 repeatedly obtains the location of the vehicle 100 from the vehicle 100. When the location of the vehicle 100 that is obtained is outside the predetermined geographical region, the server 400 remotely operates the on-board immobilizer device 20 mounted on the vehicle 100 to activate the remote immobilizer. The on-board immobilizer device 20 is configured to prohibit operation of the drive system of the vehicle 100 while the remote immobilizer is active. When the remote immobilizer is activated, the server 400 is configured to notify the terminal 300 of the authentic user of the vehicle 100 that the remote immobilizer is activated.

### Operation to Activate Remote Immobilizer

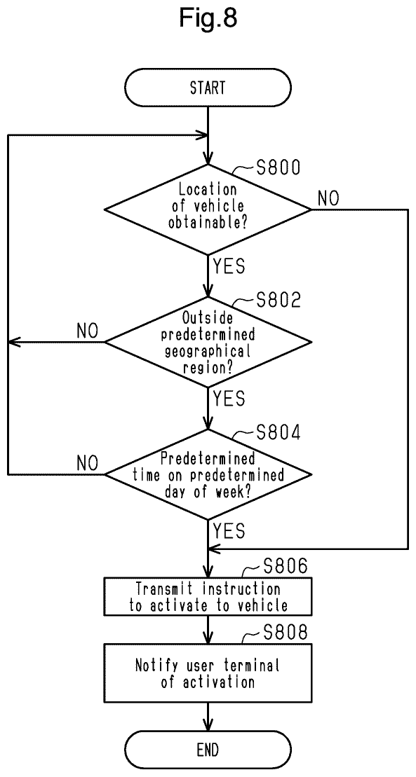

With reference to FIG. 8, the operation for activating the remote immobilizer will now be described. The process shown in FIG. 8 automatically starts subsequent to activation of the drive system of the vehicle 100. In addition, the process shown in FIG. 8 automatically starts when the remote immobilizer is switched from the active state to the inactive state during operation of the drive system of the vehicle 100.

As described above, the server 400 is configured to obtain the location of the vehicle 100 from the vehicle 100. However, when a thief removes the on-board navigation device 10 from the vehicle 100, the server 400 fails to obtain the location of the vehicle 100. In step S800, the server 400 determines whether the location of the vehicle 100 can be obtained. If the location of the vehicle 100 can be obtained (S800: YES), the server 400 proceeds to step S802. If the location of the vehicle 100 cannot be obtained (S800: NO), the server 400 proceeds to step S806.

In step S802, the server 400 determines whether the location of the vehicle 100 is outside the predetermined geographical region. In step S802, if a negative determination is made (S802: NO), the server 400 returns to step S800. In step S802, if an affirmative determination is made (S802: YES), the server 400 proceeds to step S804.

In step S804, the server 400 determines whether the current point in time belongs to a predetermined time on a predetermined day of a week. In step S804, if a negative determination is made (S804: NO), the server 400 returns to step S800. In step S804, if an affirmative determination is made (S804: YES), the server 400 proceeds to step S806.

In step S806, the server 400 transmits an instruction to activate the remote immobilizer to the vehicle 100. Then, the server 400 proceeds to step S808. In step S808, the server 400 notifies the terminal 300 of the user that the remote immobilizer is activated.

### Operation for Attempt to Activate Drive System

The operation performed when an attempt is made to activate the drive system in the first embodiment is described above with reference to FIG. 4. In the second embodiment, the process of step S406 shown in FIG. 4 is changed to the process described below and thus is different from that of the first embodiment. The vehicle 100 uses the on-board communication device 40 to transmit a request to deactivate the remote immobilizer to the server 400. The server 400 receives the request for deactivating the remote immobilizer from the vehicle 100. In response to the request, the server 400 remotely operates the on-board immobilizer device 20 mounted on the vehicle 100 to deactivate the remote immobilizer.

### Operation Related to Query About Activation State of Remote Immobilizer

In the second embodiment, with reference to FIG. 5, a process for transmitting the activation state from the server 400 to the terminal 300 will be described.

As shown in FIG. 5, in step S500, the terminal 300 of the user queries the server 400 about the activation state of the remote immobilizer. More specifically, the terminal 300 transmits a signal for querying the activation state of the remote immobilizer to the server 400. The operation for transmitting the signal is performed using an application installed on the terminal 300. The signal transmitted from the terminal 300 is received by the server 400. In step S502, the activation state of the remote immobilizer is transmitted to the terminal 300 of the user. More specifically, the server 400 transmits information indicating the activation state of the remote immobilizer to the terminal 300 that has transmitted the signal. Thus, the activation state of the remote immobilizer is notified to the terminal 300.

### Operation to Deactivate Remote Immobilizer in Response to User Request

In the second embodiment, the operation of the server 400 to deactivate the remote immobilizer in response to a request from the user will be described with reference to FIG. 6.

As shown in FIG. 6, in step S600, the terminal 300 of the user requests that the server 400 deactivate the remote immobilizer. When receiving the request, the server 400 performs user authentication. Unless the authentication is successfully completed, the request is not accepted. More specifically, a request for deactivation of the remote immobilizer is transmitted from the terminal 300 to the server 400. The operation for transmitting the request is performed using an application installed on the terminal 300. If the user authentication is successfully completed, the server 400 accepts the request from the terminal 300. In step S602, the remote immobilizer is deactivated. More specifically, the server 400 transmits an instruction to deactivate the remote immobilizer to the vehicle 100. The instruction to deactivate the remote immobilizer is received by the on-board communication device 40. The on-board communication device 40 transmits the instruction, received from the server 400, to the on-board immobilizer device 20. Then, the on-board immobilizer device 20 deactivates the remote immobilizer. In other words, the remote immobilizer is switched off from the active state.

### Operation of Second Embodiment

If the location of the vehicle 100 is outside the predetermined geographical region during the predetermined time on the predetermined day of week (S802: YES, S804: YES), the remote immobilizer is activated (S806). As described above, when the remote immobilizer is activated, the drive system of the vehicle 100 cannot be activated even using the authentic immobilizer key 70. If the location of the vehicle 100 cannot be obtained (S800: NO), the server 400 is configured to activate the remote immobilizer. That is, the remote immobilizer is activated regardless of whether the location of the vehicle 100 is outside the predetermined geographical region.

### Advantage of Second Embodiment

(2-1) The server 400 repeatedly obtains the location of the vehicle 100 from the vehicle 100. When the location of the vehicle 100 that is obtained is outside the predetermined geographical region, the server 400 remotely operates the on-board immobilizer device 20 mounted on the vehicle 100 to activate the remote immobilizer. The on-board immobilizer device 20 is configured to prohibit operation of the drive system of the vehicle 100 while the remote immobilizer is active.

This configuration obtains the same advantage as (1-1).

(2-2) When the remote immobilizer is activated, the server 400 is configured to notify the terminal 300 of the authentic user of the vehicle 100 that the remote immobilizer is activated.

This configuration obtains the same advantage as (1-2).

(2-3) When the location of the vehicle 100 obtained during the predetermined time is outside the predetermined geographical region, the server 400 is configured to activate the remote immobilizer. During time other than the predetermined time, the server 400 is configured not to activate the remote immobilizer even when the location of the vehicle 100 is outside the predetermined geographical region.

This configuration obtains the same advantage as (1-3).

(2-4) When the location of the vehicle 100 obtained on the predetermined day of week is outside the predetermined geographical region, the server 400 is configured to activate the remote immobilizer. On a day other than the predetermined day of week, the server 400 is configured not to activate the remote immobilizer even when the location of the vehicle 100 is outside the predetermined geographical region.

This configuration obtains the same advantage as (1-4).

(2-5) When the location of the vehicle 100 obtained during the predetermined time on the predetermined day of week is outside the predetermined geographical region, the server 400 is configured to activate the remote immobilizer. During time other than the predetermined time on the predetermined day of week, the server 400 is configured not to activate the remote immobilizer even when the location of the vehicle 100 is outside the predetermined geographical region.

This configuration obtains the same advantage as (1-5).

(2-6) The predetermined geographical region is set through machine learning based on travel history of the vehicle 100.

This configuration obtains the same advantage as (1-6).

(2-7) The on-board immobilizer device 20 is configured to set multiple geographical regions as the predetermined geographical region. When the vehicle 100 is moved outside of one of the predetermined geographical regions, the server 400 activates the remote immobilizer.

This configuration obtains the same advantage as (1-7).

(2-8) If the location of the vehicle 100 cannot be obtained, the server 400 is configured to activate the remote immobilizer.

This configuration obtains the same advantage as (1-8).

(2-9) When an attempt is made to activate the drive system of the vehicle 100 while the remote immobilizer is active, the on-board immobilizer device 20 shows a prompt, on the display 30 of the vehicle 100, requesting input for authentication. When predetermined identification information corresponding to the prompt is input, the on-board immobilizer device 20 is configured to transmit a request for deactivation of the remote immobilizer to the server 400. In response to the request, the server 400 is configured to remotely operate the on-board immobilizer device 20 mounted on the vehicle 100 to deactivate the remote immobilizer.

This configuration obtains the same advantage as (1-9).

(2-10) The server 400 is configured to transmit the activation state of the remote immobilizer to the terminal 300 of the authentic user of the vehicle 100 in response to a request from the terminal 300.

In this configuration, the server 400 recognizes whether the remote immobilizer is active or not. Hence, the user may check the activation state of the remote immobilizer by performing an inquiry on the server 400.

(2-11) The server 400 is configured to deactivate the remote immobilizer when receiving a request for deactivation of the remote immobilizer from the terminal 300 of the authentic user of the vehicle 100 while the remote immobilizer is active.

This configuration obtains the same advantage as (1-11).

### Third Embodiment

A third embodiment will now be described with reference to the drawings. In the third embodiment, the same configurations as the first embodiment will not be described in detail.

The first and third embodiments are the same in the point in which the vehicle 100 determines whether the location of the vehicle 100 is outside the predetermined geographical region. In the first embodiment, only the vehicle 100 activates the remote immobilizer. In the third embodiment, the vehicle 100 requests an instruction to activate the remote immobilizer from the server 400. In response to the request, the server 400 transmits an instruction to activate the remote immobilizer to the vehicle 100.

### Overview

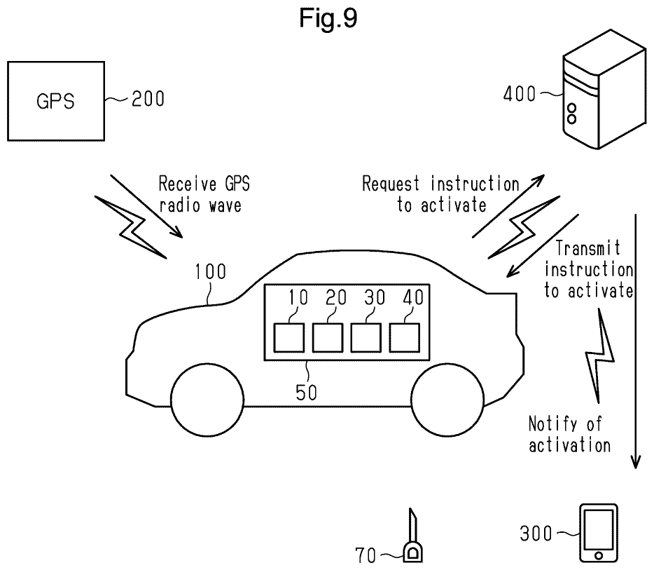

The overview of the third embodiment will now be described with reference to FIG. 9. The vehicle control system includes the vehicle 100 and the server 400. The vehicle 100 repeatedly obtains the location of the vehicle 100. When the location of the vehicle 100 that is obtained is outside the predetermined geographical region, the vehicle 100 requests that the server 400 transmit an instruction to activate the remote immobilizer to the vehicle 100. When receiving the request, the server 400 transmits the instruction to activate the remote immobilizer to the vehicle 100. As a result, the on-board immobilizer device 20 mounted on the vehicle 100 is remotely operated to activate the remote immobilizer. While the remote immobilizer is active, the on-board immobilizer device 20 prohibits operation of a drive system of the vehicle 100. When the remote immobilizer is activated, the server 400 is configured to notify the terminal 300 of the authentic user of the vehicle 100 that the remote immobilizer is activated.

### Operation to Activate Remote Immobilizer

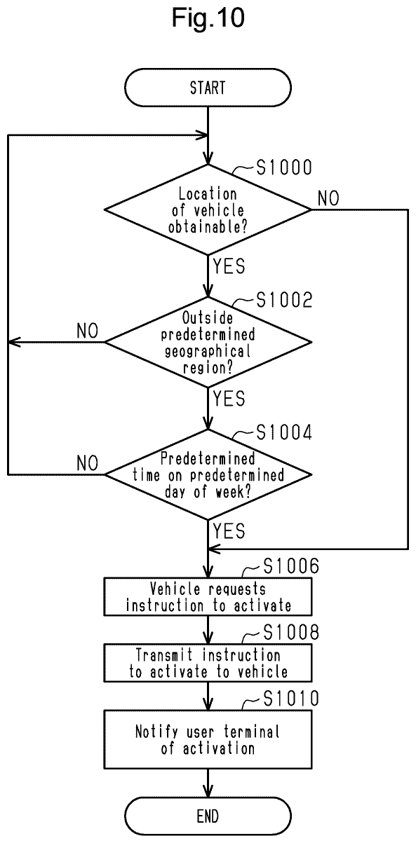

With reference to FIG. 10, the operation for activating the remote immobilizer will now be described. The process shown in FIG. 10 automatically starts subsequent to activation of the drive system of the vehicle 100. In addition, the process shown in FIG. 10 automatically starts when the remote immobilizer is switched from the active state to the inactive state during operation of the drive system of the vehicle 100.

As described above, the on-board immobilizer device 20 is configured to obtain the location of the vehicle 100. However, when a thief removes the on-board navigation device 10 from the vehicle 100, the on-board immobilizer device 20 fails to obtain the location of the vehicle 100. In step S1000, the on-board immobilizer device 20 determines whether the location of the vehicle 100 can be obtained. If the location of the vehicle 100 can be obtained (S1000: YES), the on-board immobilizer device 20 proceeds to step S1002. If the location of the vehicle 100 cannot be obtained (S1000: NO), the on-board immobilizer device 20 proceeds to step $1006.

In step S1002, the on-board immobilizer device 20 determines whether the location of the vehicle 100 is outside the predetermined geographical region. If a negative determination is made in step S1002 (S1002: NO), the on-board immobilizer device 20 returns to step S1000. If an affirmative determination is made in step S1002 (S1002: YES), the on-board immobilizer device 20 proceeds to step S1004.

In step S1004, the on-board immobilizer device 20 determines whether the current point in time belongs to a predetermined time on a predetermined day of week. If a negative determination is made in step S1004 (S1004: NO), the on-board immobilizer device 20 returns to step S1000. If an affirmative determination is made in step S1004 (S1004: YES), the on-board immobilizer device 20 proceeds to step S1006.

In step S1006, the on-board immobilizer device 20 requests an instruction to activate the remote immobilizer from the server 400. In step S1008, the server 400 transmits an instruction to activate the remote immobilizer to the vehicle 100. The server 400 proceeds to step S1010. In step S1010, the server 400 notifies the terminal 300 of the user that the remote immobilizer is activated.

### Operation for Attempt to Activate Drive System

The operation performed when an attempt is made to activate the drive system in the first embodiment is described above with reference to FIG. 4. In the third embodiment, the process of step S406 shown in FIG. 4 is changed to the process described below and thus is different from that of the first embodiment. The vehicle 100 uses the on-board communication device 40 to transmit a request to deactivate the remote immobilizer to the server 400. The server 400 receives the request for deactivating the remote immobilizer from the vehicle 100. In response to the request, the server 400 remotely operates the on-board immobilizer device 20 mounted on the vehicle 100 to deactivate the remote immobilizer.

### Operation Related to Query About Activation State of Remote Immobilizer

In the third embodiment, the operation related to a query about the activation state of the remote immobilizer is the same as that in the first embodiment.

### Operation to Deactivate Remote Immobilizer in Response to User Request

In the third embodiment, a first example of the operation to deactivate the remote immobilizer in response to a request from the user will now be described. In the first example, the server 400 receives a request to deactivate the remote immobilizer from the terminal 300 and then remotely deactivates the remote immobilizer.

The first example will now be described in detail with reference to FIG. 6. In step S600, the terminal 300 of the user requests the server 400 to deactivate the remote immobilizer. When receiving the request, the server 400 performs user authentication. Unless the authentication is successfully completed, the request is not accepted. More specifically, a request for deactivation of the remote immobilizer is transmitted from the terminal 300 to the server 400. The operation for transmitting the request is performed using an application installed on the terminal 300. If the user authentication is successfully completed, the server 400 accepts the request from the terminal 300. In step S602, the remote immobilizer is deactivated. The specific process is as follows. The server 400 transmits an instruction to deactivate the remote immobilizer to the vehicle 100. The on-board communication device 40 notifies the on-board immobilizer device 20 that the request for deactivation of the remote immobilizer is received. Then, the on-board immobilizer device 20 deactivates the remote immobilizer. In other words, the remote immobilizer is switched off from the active state.

In the third embodiment, a second example of the operation to deactivate the remote immobilizer in response to a request from the user will now be described. In the second example, the vehicle 100 receives a request to deactivate the remote immobilizer from the terminal 300 and then deactivates the remote immobilizer.

The second example will now be described in detail with reference to FIG. 6. In step S600, the terminal 300 of the user requests the vehicle 100 to deactivate the remote immobilizer. In this case, the vehicle 100, which has received the request, performs user authentication. Unless the authentication is successfully completed, the request is not accepted. More specifically, a request for deactivation of the remote immobilizer is transmitted from the terminal 300 to the vehicle 100. The operation for transmitting the request is performed using an application installed on the terminal 300. If the user authentication is successfully completed, the on-board communication device 40 accepts the request from the terminal 300. In step S602, the remote immobilizer is deactivated. More specifically, the on-board communication device 40 requests that the server 400 transmit an instruction to deactivate the remote immobilizer. Then, the server 400 transmits an instruction to deactivate the remote immobilizer to the vehicle 100. The instruction to deactivate the remote immobilizer is received by the on-board communication device 40. The on-board communication device 40 transmits the instruction to deactivate the remote immobilizer to the on-board immobilizer device 20. Then, the on-board immobilizer device 20 deactivates the remote immobilizer. In other words, the remote immobilizer is switched off from the active state.

### Operation of Third Embodiment

If the location of the vehicle 100 is outside the predetermined geographical region during the predetermined time on the predetermined day of week (S1002: YES, S1004: YES), the remote immobilizer is activated (S1006, S1008). As described above, when the remote immobilizer is active, the drive system of the vehicle 100 cannot be activated even using the authentic immobilizer key 70. If the location of the vehicle 100 cannot be obtained (S1000: NO), the vehicle 100 requests that the server 400 transmit an instruction to activate the remote immobilizer to the vehicle 100. Thus, the remote immobilizer is activated regardless of whether the location of the vehicle 100 is outside the predetermined geographical region.

### Advantage of Third Embodiment

(3-1) The vehicle control system includes the vehicle 100 and the server 400. The vehicle 100 repeatedly obtains the location of the vehicle 100. When the location of the vehicle 100 that is obtained is outside the predetermined geographical region, the vehicle 100 requests that the server 400 transmit an instruction to activate the remote immobilizer to the vehicle 100. When receiving the request, the server 400 transmits an instruction to activate the remote immobilizer to the vehicle 100. Thus, the server 400 remotely operates the on-board immobilizer device 20, which is mounted on the vehicle 100, to activate the remote immobilizer. The on-board immobilizer device 20 is configured to prohibit operation of the drive system of the vehicle 100 while the remote immobilizer is active.

This configuration obtains the same advantage as (1-1).

(3-2) When the remote immobilizer is activated, the server 400 is configured to notify the terminal 300 of the authentic user of the vehicle 100 that the remote immobilizer is activated.

This configuration obtains the same advantage as (1-2).

(3-3) When the location of the vehicle 100 obtained during the predetermined time is outside the predetermined geographical region, the server 400 is configured to activate the remote immobilizer. During time other than the predetermined time, the server 400 is configured not to activate the remote immobilizer even when the location of the vehicle 100 is outside the predetermined geographical region.

This configuration obtains the same advantage as (1-3).

(3-4) When the location of the vehicle 100 obtained on the predetermined day of week is outside the predetermined geographical region, the server 400 is configured to activate the remote immobilizer. On a day other than the predetermined day of week, the server 400 is configured not to activate the remote immobilizer even when the location of the vehicle 100 is outside the predetermined geographical region.

This configuration obtains the same advantage as (1-4).

(3-5) When the location of the vehicle 100 obtained during the predetermined time on the predetermined day of week is outside the predetermined geographical region, the server 400 is configured to activate the remote immobilizer. During time other than the predetermined time on the predetermined day of week, the server 400 is configured not to activate the remote immobilizer even when the location of the vehicle 100 is outside the predetermined geographical region.

This configuration obtains the same advantage as (1-5).

(3-6) The predetermined geographical region is set through machine learning based on travel history of the vehicle 100.

This configuration obtains the same advantage as (1-6).

(3-7) The on-board immobilizer device 20 is configured to set multiple geographical regions as the predetermined geographical region. When the vehicle 100 is moved outside of one of the predetermined geographical regions, the server 400 activates the remote immobilizer.

This configuration obtains the same advantage as (1-7).

(3-8) When the location of the vehicle 100 cannot be obtained, the vehicle 100 is configured to request that the server 400 transmit an instruction to activate the remote immobilizer to the vehicle 100.

This configuration obtains the same advantage as (1-8).

(3-9) When an attempt is made to activate the drive system of the vehicle 100 while the remote immobilizer is active, the on-board immobilizer device 20 shows a prompt, on the display 30 of the vehicle 100, requesting input for authentication. When predetermined identification information corresponding to the prompt is input, the on-board immobilizer device 20 is configured to transmit a request for deactivation of the remote immobilizer to the server 400. In response to the request, the server 400 is configured to remotely operate the on-board immobilizer device 20 mounted on the vehicle 100 to deactivate the remote immobilizer.

This configuration obtains the same advantage as (1-9).

(3-10) The server 400 is configured to transmit the activation state of the remote immobilizer to the terminal 300 of the authentic user of the vehicle 100 in response to a request from the terminal 300.

In this configuration, the server 400 recognizes whether the remote immobilizer is active or not. Hence, the user may check the activation state of the remote immobilizer by performing an inquiry on the server 400.

(3-11) The server 400 is configured to deactivate the remote immobilizer when receiving a request for deactivation of the remote immobilizer from the terminal 300 of the authentic user of the vehicle 100 while the remote immobilizer is active.

This configuration obtains the same advantage as (1-11).

### MODIFIED EXAMPLES

The followings are modifications commonly applicable to the first to third embodiments. The following modifications can be combined as long as the combined modifications remain technically consistent with each other.

In the first to third embodiments, a normal immobilizer and a remote immobilizer are combined. However, this is only an example. The normal immobilizer may be omitted. That is, the remote immobilizer may be singly used.

In FIG. 2, one or more of steps S200, S204, and S208 may be omitted.

The diagram shown in FIG. 3 may be changed in any manner. In an example, only time may be set. In an example, only a day of week may be set. In an example, only a date may be set. In an example, a period including multiple days may be set.

The process shown in FIG. 5 may be omitted.

At least one of the process shown in FIG. 4 and the process shown in FIG. 6 may be omitted. When the processes shown in FIGS. 4 and 6 are omitted, for example, the remote immobilizer may be configured to be deactivated by a user calling a call center.

In FIG. 8, at least one of steps S800, S804, and S808 may be omitted.

In FIG. 10, at least one of steps 1000, S1004, S1010 may be omitted.

In the first to third embodiments, in step S402, the on-board immobilizer device 20 shows a prompt, on the display 30 of the vehicle 100, requesting input for authentication. However, this is only an example. In step S402, the on-board immobilizer device 20 may show a prompt requesting input for authentication on an indicator other than the display 30 of the vehicle 100. The indicator may include the screen of the terminal 300.

In the first to third embodiments, the server 400 includes CPU, RAM, and ROM. The server 400 executes a software process. However, this is only an example. In another example, the server 400 may include a dedicated hardware circuit (such as application specific integrated circuit, ASIC) that executes at least part of the software processing performed in the above embodiment. More specifically, the server 400 may have any of the following configurations (a) to (c). (a) The server 400 includes a processing device for executing all processes in accordance with a program and a program storage device such as a ROM for storing the program. In other words, the server 400 includes a software execution device. (b) The server 400 includes a processor that executes part of processes according to a program and a program storage device. The server 400 further includes a dedicated hardware circuit that executes the remaining processes. (c) The server 400 further includes a dedicated hardware circuit that executes all of the processes. Multiple software execution devices and/or multiple dedicated hardware circuits may be provided. That is, the above-described processes may be executed by processing circuitry including at least one of a software execution device and a dedicated hardware circuit. The processing circuitry may include multiple software execution devices and multiple dedicated hardware circuits. The program storage device, or computer readable medium, includes any type of storage device that is a medium accessible by a versatile computer or a dedicated computer. The processing circuitry may execute a process of the control unit 50 and a process of the terminal 300 of the user. The control unit 50 includes the on-board navigation device 10, the on-board immobilizer device 20, and the display 30, and the on-board communication device 40.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle, comprising:
an on-board navigation device configured to obtain a location of the vehicle; and
an on-board immobilizer device, wherein
the on-board immobilizer device is configured to activate a function of a remote immobilizer when the location of the vehicle obtained from the on-board navigation device is outside a predetermined geographical region, the function of the remote immobilizer prohibiting operation of a drive system of the vehicle through a remote operation, and
the on-board immobilizer device is configured to prohibit operation of the drive system of the vehicle while the function of the remote immobilizer is active.

2. The vehicle according to claim 1, further comprising:
an on-board communication device configured to communicate with a device arranged outside the vehicle,
wherein when the on-board immobilizer device activates the remote immobilizer, the on-board communication device is configured to notify a terminal of an authentic user of the vehicle that the remote immobilizer is activated.

3. The vehicle according to claim 1, wherein
when the location of the vehicle obtained during a predetermined time is outside the predetermined geographical region, the on-board immobilizer device is configured to activate the remote immobilizer, and
during a time other than the predetermined time, even when the location of the vehicle is outside the predetermined geographical region, the on-board immobilizer device is configured to not activate the remote immobilizer.

4. The vehicle according to claim 1, wherein
when the location of the vehicle obtained on a predetermined day of week is outside the predetermined geographical region, the on-board immobilizer device is configured to activate the remote immobilizer, and
on a day other than the predetermined day of week, the on-board immobilizer device is configured to not activate the remote immobilizer even when the location of the vehicle is outside the predetermined geographical region.

5. The vehicle according to claim 1, wherein
when the location of the vehicle obtained during a predetermined time on a predetermined day of week is outside the predetermined geographical region, the on-board immobilizer device is configured to activate the remote immobilizer, and
during a time other than the predetermined time on the predetermined day of week, the on-board immobilizer device is configured to not activate the remote immobilizer even when the location of the vehicle is outside the predetermined geographical region.

6. The vehicle according to claim 1, wherein the predetermined geographical region is set through machine learning based on a travel history of the vehicle.

7. The vehicle according to claim 1, wherein when the predetermined geographical region includes multiple geographical regions and the vehicle is moved outside of one of the geographical regions, the on-board immobilizer device is configured to activate the remote immobilizer.

8. The vehicle according to claim 1, wherein the on-board immobilizer device is configured to activate the remote immobilizer when failing to obtain the location of the vehicle from the on-board navigation device.

9. The vehicle according to claim 1, wherein
when an attempt is made to activate the drive system of the vehicle while the remote immobilizer is active, the on-board immobilizer device is configured to show a prompt on an indicator, the prompt requesting an input for authentication, and
the on-board immobilizer device is configured to deactivate the remote immobilizer when predetermined identification information corresponding to the prompt is input.

10. The vehicle according to claim 1, further comprising:
an on-board communication device configured to communicate with a device arranged outside the vehicle,
wherein the on-board communication device is configured to transmit an activation state of the remote immobilizer to a terminal of an authentic user of the vehicle in response to a request from the terminal.

11. The vehicle according to claim 1, further comprising:
an on-board communication device configured to communicate with a device arranged outside the vehicle,
wherein the on-board communication device is configured to deactivate the remote immobilizer when receiving a request for deactivation of the remote immobilizer from a terminal of an authentic user of the vehicle while the remote immobilizer is active.

12. A server, comprising:
processing circuitry configured to
obtain a location of a vehicle from the vehicle, and
remotely operate an on-board immobilizer device mounted on the vehicle to activate a function of a remote immobilizer when the location of the vehicle that is obtained is outside a predetermined geographical region,
wherein the on-board immobilizer device is configured to prohibit operation of a drive system of the vehicle while the function of the remote immobilizer is active.

13. The server according to claim 12, wherein when activating the remote immobilizer, the processing circuitry is configured to notify a terminal of an authentic user of the vehicle that the remote immobilizer is activated.

14. The server according to claim 12, wherein
when the location of the vehicle obtained during a predetermined time is outside the predetermined geographical region, the processing circuitry is configured to activate the remote immobilizer, and
during a time other than the predetermined time, the processing circuitry is configured to not activate the remote immobilizer even when the location of the vehicle is outside the predetermined geographical region.

15. The server according to claim 12, wherein
when the location of the vehicle obtained on a predetermined day of week is outside the predetermined geographical region, the processing circuitry is configured to activate the remote immobilizer, and
on a day other than the predetermined day of week, the processing circuitry is configured to not activate the remote immobilizer even when the location of the vehicle is outside the predetermined geographical region.

16. The server according to claim 12, wherein
when the location of the vehicle obtained during a predetermined time on a predetermined day of week is outside the predetermined geographical region, the processing circuitry is configured to activate the remote immobilizer, and
during a time other than the predetermined time on the predetermined day of week, the processing circuitry is configured to not activate the remote immobilizer even when the location of the vehicle is outside the predetermined geographical region.

17. A vehicle control system, comprising:
a vehicle; and
a server, wherein
the vehicle is configured to
obtain a location of the vehicle, and
request that the server transmit an instruction to the vehicle for activating a function of a remote immobilizer through a remote operation when the location of the vehicle that is obtained is outside a predetermined geographical region, the function of the remote immobilizer prohibiting operation of a drive system of the vehicle,
when receiving the request, the server is configured to transmit the instruction for activating the function of the remote immobilizer to the vehicle so that an on-board immobilizer device mounted on the vehicle is remotely operated to activate the function of the remote immobilizer, and
the on-board immobilizer device is configured to prohibit operation of the drive system of the vehicle while the function of the remote immobilizer is active.

18. The vehicle control system according to claim 17, wherein when the remote immobilizer is activated, the server is configured to notify a terminal of an authentic user of the vehicle that the remote immobilizer is activated.

19. The vehicle control system according to claim 17, wherein
when the location of the vehicle obtained during a predetermined time is outside the predetermined geographical region, the server is configured to activate the remote immobilizer, and
during a time other than the predetermined time, the server is configured to not activate the remote immobilizer even when the location of the vehicle is outside the predetermined geographical region.

20. The vehicle control system according to claim 17, wherein
when the location of the vehicle obtained on a predetermined day of week is outside the predetermined geographical region, the server is configured to activate the remote immobilizer, and
on a day other than the predetermined day of week, the server is configured to not activate the remote immobilizer even when the location of the vehicle is outside the predetermined geographical region.
